(19) United States
(12) Patent Application Publication
(10) Pub. No.: US 2019/0213475 A1
(43) Pub. Date: Jul. 11, 2019

(54) REDUCING MACHINE-LEARNING MODEL COMPLEXITY WHILE MAINTAINING ACCURACY TO IMPROVE PROCESSING SPEED

(71) Applicant: Red Hat, Inc., Raleigh, NC (US)

(72) Inventor: Erik Jordan Erlandson, Tempe, AZ (US)

(21) Appl. No.: 15/866,970

(22) Filed: Jan. 10, 2018

(51) Int. Cl. G06N 3/08; G06N 3/04; G06K 9/62

(52) U.S. Cl. CPC G06N 3/08; G06N 3/0454; G06K 9/6259; G06K 9/6223; G06K 9/6282; G06K 9/6269

(57) ABSTRACT

One example of the present disclosure can include a computing device identifying parameters for configuring a machine-learning model. The computing device can then determine descriptor values for multiple versions of the machine-learning model by, for each parameter in the group of parameters: (i) adjusting the parameter's value to generate a modified version of the machine-learning model; (ii) training the modified version of the machine-learning model to determine a likelihood function for the modified version of the machine-learning model; and (iii) determining a descriptor value for the modified version of the machine-learning model using the number of parameters in the group of parameters and the likelihood function. The computing device can then select a particular version of the machine-learning model based on the particular version having the lowest descriptor value among all the descriptor values. The computing device can execute the particular version of the machine-learning model to perform a task.

### TECHNICAL FIELD

The present disclosure relates generally to computer processing efficiency. More specifically, but not by way of limitation, this disclosure relates to reducing machine-learning model complexity while maintaining accuracy to improve processing speed.

### BACKGROUND

Machine-learning models have become more prevalent in recent years for performing a variety of computing tasks, Machine-learning models are created by model designers, which may or may not have a good understanding of the inner workings of the machine-learning models. Often, model designers will simply increase the size (e.g., topology, complexity, or both) of machine-learning models to improve the accuracy of the machine-learning models.

### BRIEF DESCRIPTION OF THE DRAWINGS

FIG. 1 is a block diagram of an example of a computing device for reducing machine-learning model complexity while maintaining accuracy to improve processing speed according to some aspects.

FIG. 2 is a flow chart of an example of a process for reducing machine-learning model complexity while maintaining accuracy to improve processing speed according to some aspects.

### DETAILED DESCRIPTION

There can be disadvantages to simply increasing the size of a machine-learning model to improve accuracy. For example, this can dramatically increase the processing time required to execute the machine-learning model. As a particular example, a machine-learning model with 90% accuracy may take between 5 seconds and 10 seconds to fully execute. To improve the machine-learning model's accuracy to above 95%, a model designer may add a large number of hidden layers and nodes to the machine-learning model. But this increase in size can result in the machine-learning model taking between 1 minute and 10 minutes to fully execute, which is more than a 10-fold increase in processing time for only a 5% increase in accuracy. And although there may be other, more suitable ways to improve the accuracy of the machine-learning model without dramatically impacting processing time, model designers are often unaware of these options because machine-learning models are typically poorly understood and considered “black boxes.” As a result, model designers may unwittingly add unnecessary complexity to machine-learning models, typically at the expense of processing speed.

Some examples of the present disclosure overcome one or more of the abovementioned issues by identifying a version of a machine-learning model that has an optimal tradeoff between size and accuracy for use in performing a computing task. A computing device can then perform the computing task using that version of the machine-learning model (as opposed to other versions of the machine-learning model). By using that version of the machine-learning model to perform the computing task, processing time can be reduced while accuracy is maintained.

As a particular example, a computing device can determine some or all of the parameters (e.g., hyperparameters) for configuring a machine-learning model. The computing device can then automatically and iteratively adjust each of the parameters, individually or in combination, to create separate versions of the machine-learning model. For example, if there are 10 parameters, with each parameter having 5 possible values, the computing device may repeat this process 5̂10=9,765,625 times to create 9,765,625 individual versions of the machine-learning model for each possible parameter-value. Additionally or alternatively, the computing device may adjust combinations of the parameters to create, for example, several hundred-thousand versions of the machine-learning model. The computing device can train each version of the machine-learning model using training data. Next, the computing device can determine a descriptor value for each version of the machine-learning model. The descriptor value can be a single, numeric value that represents a tradeoff between model size and accuracy. In some examples, the computing device can determine a descriptor value for a version of the machine-learning model using the following equation:

Descriptor Value=C1*(Num_{P})+C2*ln(\hat{L})

where C1 and C2 are constants, Num_{P} is the number of parameters for configuring the machine-learning model (e.g., 10), and \hat{L} is the maximum value of a likelihood function for the version of the machine-learning model. A user may specify the value of the constants, or the constants can have a default value (e.g., 2). The computing device can compare the descriptor values for some or all of the versions of the machine-learning model to determine which version of the machine-learning model has the lowest descriptor value. The version of the machine-learning model with the lowest descriptor value may be the version that has the optimal tradeoff between size and accuracy. The computing device can then select the version of the machine-learning model with the lowest descriptor value for performing a computing task. By performing the computing task using the version of the machine-learning model with the optimal tradeoff between size and accuracy, the computing device can consume fewer computing resources (e.g., processing power, processing cycles, processing time, memory, etc.) to perform the computing task than by using other versions of the machine-learning model.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

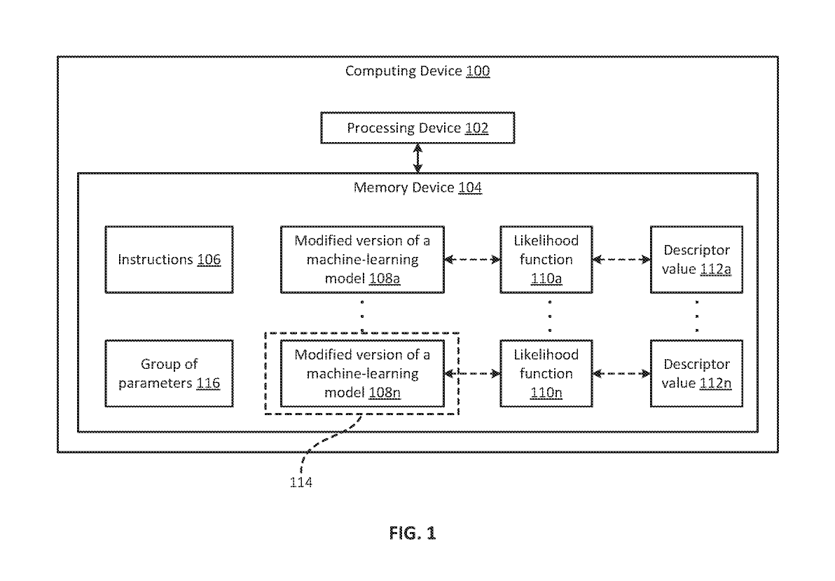

FIG. 1 is a block diagram of an example of a computing device 100 for reducing machine-learning model complexity while maintaining accuracy to improve processing speed according to some aspects. Examples of the computing device 100 can include a server, desktop computer, laptop computer, mobile device, node in a cloud computing environment or cluster, or any combination of these.

The computing device 100 can include a processing device 102 communicatively coupled to a memory device 104. The processing device 102 can include one processing device or multiple processing devices. Non-limiting examples of the processing device 102 include a Field-Programmable Gate Array (FPGA), an application-specific integrated circuit (ASIC), a microprocessor, etc. The processing device 102 can execute one or more operations for allocating computing resources. The processing device 102 can execute instructions 106 stored in the memory device 104 to perform the operations. In some examples, the instructions 106 can include processor-specific instructions generated by a compiler or an interpreter from code written in any suitable computer-programming language, such as C, C++, C#, etc.

Memory device 104 can include one memory device or multiple memory devices. The memory device 104 can be non-volatile and may include any type of memory device that retains stored information when powered off. Non-limiting examples of the memory device 104 include electrically erasable and programmable read-only memory (EEPROM), flash memory, or any other type of non-volatile memory. In some examples, at least some of the memory device can include a medium from which the processing device 102 can read instructions 106. A computer-readable medium can include electronic, optical, magnetic, or other storage devices capable of providing the processing device with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read instructions 106.

The computing device 100 can execute a machine-learning model. Examples of the machine-learning model can include (i) a neural network; (ii) a decision tree, such as a classification tree or regression tree; (iii) a classifier, such as naïve bias classifier, logistic regression classifier, random forest classifier, or a support vector machine; (iv) a clusterer, such as a k-means clusterer; or (v) any combination of these. But the machine-learning model may consume a lot of computing resources to execute. So, the computing device 100 may be able to determine a version of the machine-learning model that has a smaller size with an acceptable level of accuracy in order to reduce the computing resources consumed to execute the model.

For example, the computing device 100 can determine a group of parameters 116 for configuring the machine-learning model. The group of parameters 116 can include all of, or only a subset of, the possible parameters for configuring the machine-learning model. Some of the parameters in the group of parameters 116 can control the size of the machine-learning model. These parameters can be referred to as structural parameters. Examples of structural parameters can include (i) the number of layers in a neural network, (ii) how the layers are connected to one another, (iii) the number of nodes in a layer, (iv) the number of weights in a layer, (v) a maximum depth for a decision tree, or (vi) any combination of these. Other parameters in the group of parameters 116 may control characteristics other than the size of the machine-learning model (e.g., may not directly affect the size of the machine-learning model). These parameters can be referred to as non-structural parameters. Examples non-structural parameters can include (i) a batch size indicating the amount of training data to treat as a single batch of data for processing by the machine-learning model, (ii) a learning rate, (iii) a momentum term for backpropagation, (iv) an activation function, (v) a boosting rate; (vi) a random sampling rate for training data; (vii) a random sampling rate for features to test; (viii) a split criterion for splitting a set of data into subsets; or (ix) any combination of these. The computing device 100 can determine the group of parameters 116, for example, from user input, a configuration file, or another data source.

The computing device 100 can then adjust the values of the parameters in the group of parameters 116 to create modified versions of the machine-learning model 108a-n. For example, the computing device 100 can individually adjust the value of each parameter in the group of parameters 116 to create the modified versions of the machine-learning model 108a-n. As a specific example, if there are 20 parameters in the group of parameters 116, with each parameter having three possible values, the computing device 100 can adjust the values of the parameters 3̂20=3,486,784,401 times to create 3,486,784,401 modified versions of the machine-learning model for each possible parameter-value. In another example, there may be 25 parameters in the group of parameters 116, with each parameter having six possible values. But the computing device 100 may only adjust 10 of the parameters, with each of the 10 parameters being adjusted to two of the six possible values. This may result in 2̂10=1,024 modified versions of the machine-learning model. In still another example, the computing device 100 can adjust the values of various combinations of parameters concurrently in the group of parameters 116 to create the modified versions of the machine-learning model 108a-n. This may result in several million modified versions of the machine-learning model 108a-n. The computing device 100 can adjust any number and combination of parameters in the group of parameters 116 to any number and combination of values to create any number and combination of modified versions of the machine-learning model 108a-n. In some examples, the computing device 100 can determine the parameters to adjust and/or the values for those parameters using an optimization algorithm, such as gradient optimization or pseudo gradient optimization.

After creating the modified versions of the machine-learning model 108a-n, the computing device 100 can train modified versions of the machine-learning model 108a-n. For example, the computing device 100 can supply training data as input to the modified versions of the machine-learning model 108a-n to tune various weights in the modified versions of the machine-learning model 108a-n. This can transform the modified versions of the machine-learning model 108a-n from untrained models to trained models,

The computing device 100 can then determine a respective likelihood function 110a for each of the modified versions of the machine-learning model 108a-n. A likelihood function (L) can express the probability of the observed data from the perspective of a machine-learning model (M) having parameters (θ). The likelihood function can be expressed as:

L(θ)=P(L|θ, M)

Stated differently, the likelihood function can express the probability of the observed data if the machine-learning model has a particular set of parameters (θ). If a set of parameters θ₁ results in a higher likelihood L(θ₁) than another set of parameters θ₂, then the observed data is more probable given θ₁ than θ₂. For example, the observed data can be training data. And after training the modified versions of the machine-learning model 108a-n using the training data, each of the modified versions of the machine-learning model 108a-n can have parameters that are tuned to different values. The likelihood functions 110a-n can indicate the probability of the training data from the perspective of the machine-learning model having the various tunings of the parameter values in the modified versions of the machine learning model 108a-n. If a first set of parameter tunings results in a higher likelihood than a second set of parameter tunings, then the training data is more probable given the first set of parameter tunings than the second set of parameter tunings. This can indicate that the modified version of the machine-learning model 108n having the first set of parameter tunings is likely more accurate than the modified version of the machine-learning model 108a having the second set of parameter tunings.

After determining the likelihood functions 110a-n for the modified versions of the machine-learning model 108a-n, the computing device 100 can determine descriptor values 112a-n (e.g., description lengths) for the modified versions of the machine-learning model 108a-n. In some examples, the computing device 100 can determine a respective descriptor value for each of the modified versions of the machine-learning model 108a-n. For example, to determine a descriptor value 112a for the modified version of the machine-learning model 108a, the computing device 100 can multiply a first constant by the number of parameters in the group of parameters 116 to determine a first value. The computing device 100 can also multiply a second constant by the logarithm of a maximum value of a likelihood function (e.g., ln(\hat{L})) to determine a second value. The computing device 100 can then determine the descriptor value 112a by adding the first value and the second value. In this example, the descriptor value 112a is partially based on (i) the number of parameters in the group of parameters 116, which can indicate the size of the model; and (ii) the likelihood function, which can indicate the accuracy of the model. So, the descriptor value 112a can be a single value representing a tradeoff between size and accuracy. If one of these factors (size or accuracy) is more important to a user than the other, the user can adjust the first constant or the second constant as desired to more heavily weight the size or accuracy, respectively.

Other methods of determining a descriptor value 112a are also possible. For example, the computing device 100 can perform multi-objective optimization, in which multiple objective-functions are optimized simultaneously. By performing multi-objective optimization, the computing device 100 can determine an optimal tradeoff between two or more conflicting objectives, such as the size and accuracy of a machine-learning model. The computing device 100 can assign each of the modified versions of the machine-learning model 108a-n with a respective numerical value indicating its relationship to the multi-objective optimization results. This numerical value can be used as the descriptor value 112a. In some examples, the computing device 100 can determine Pareto points (e.g., points indicating non-dominated solutions in a multi-objective optimization problem) and plot the Pareto points in a graph to form a multidimensional surface (e.g., a Pareto surface). The graph can have an indicator of model accuracy along a first axis, such as an X axis. The indicator of model accuracy can be the accuracy itself (e.g., 95% or 0.95), a maximum value of a likelihood function (e.g., \hat{L}), a logarithm of the maximum value of the likelihood function (e.g., ln(\hat{L})), or another value that represents model accuracy. The graph can also have the number of parameters in the group of parameters 116 along a second axis, such as a Y axis. The computing device 100 can identify a plot point on the surface and determine the descriptor value 112a based on the plot point (e.g., use a value of the plot point as the descriptor value 112a).

After determining descriptor values 112a-n, the computing device 100 can compare some or all of the descriptor values 112a-n to one another to determine which of the modified versions of the machine-learning models 108a-n has the lowest descriptor value. For example, the computing device 100 can determine that the modified version of the machine-learning model 108a has a descriptor value of 2.2 and the modified version of the machine-learning model 108n has a descriptor value of 1.8. So, the computing device 100 can determine that the modified version of the machine-learning model 108n has the lower descriptor value. This process can repeat until the computing device 100 determines that a particular version of the machine-learning model 114 has the lowest descriptor value. In the example shown in FIG. 1 the particular version of the machine-learning model 114 that has the lowest descriptor value is version 108n, as indicated by the dashed box. The particular version of the machine-learning model 114 that has the lowest descriptor value may be the version that has a predefined or optimal tradeoff between size and accuracy.

Based on determining that the particular version of the machine-learning model 114 that has the lowest descriptor value, the computing device 100 can select the particular version of the machine-learning model 114 for performing a task. The task can be a computing task, such as generating a predictive forecast, predicting a result, or analyzing data. Selecting the particular version of the machine-learning model 114 to perform the task, as opposed to other versions of the machine-learning model, may result in the task being executed faster.

In some examples, the computing device 100 can perform some or all of the above process (e.g., in parallel) for several different types of machine-learning models. For example, the computing device 100 can perform the above process for a neural network to identify which version of the neural network has the lowest descriptor value. This version of the neural network can be referred to as the champion version of the neural network. The computing device 100 can also perform the above process for a decision tree to determine which version of the decision tree has the lowest descriptor value. This version of the decision tree can be referred to as the champion version of the decision tree. The computing device 100 can then determine whether the champion version of the neural network has a lower descriptor value than the champion version of the decision tree. If so, the computing device 100 can select the champion version of the neural network to perform the task. Otherwise, the computing device 100 can select the champion version of the decision tree to perform the task. In this manner, the computing device 100 can use the descriptor values for different types of machine-learning models to select among the different types of machine-learning models.

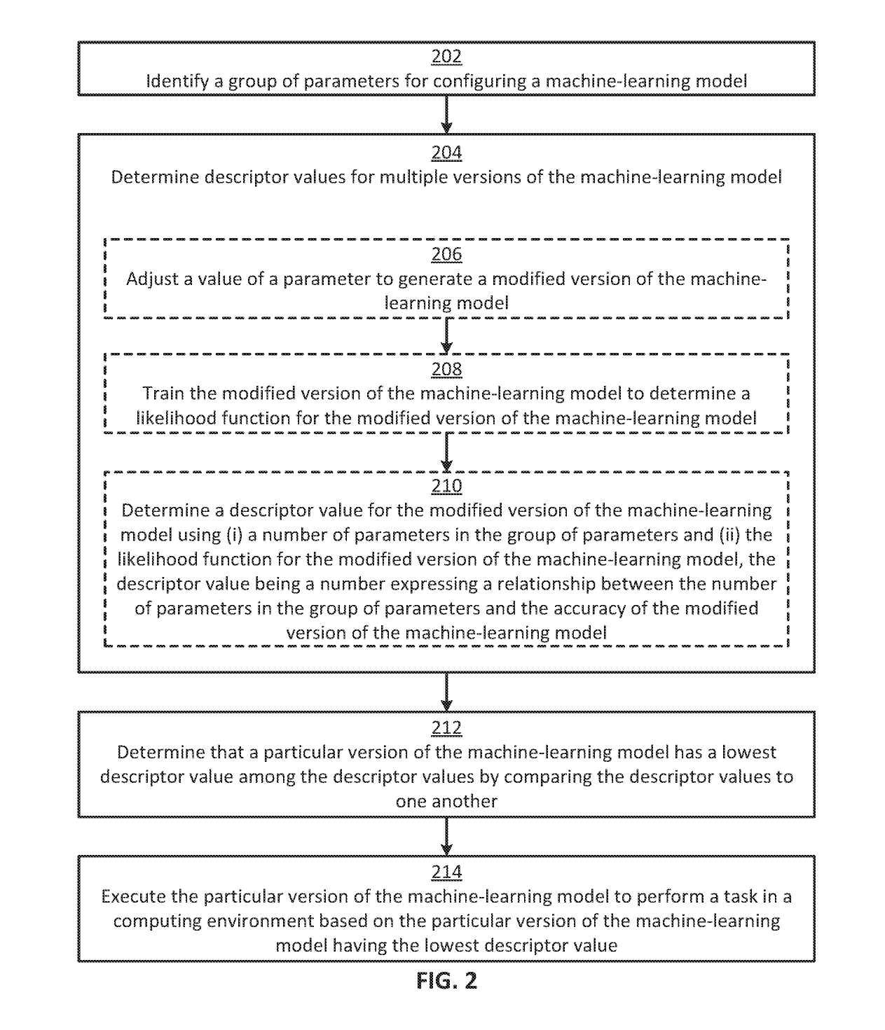

In some examples, the computing device 100 can perform one or more of the steps shown in FIG. 2 according to some aspects. In other examples, the computing device 100 can implement more steps, fewer steps, different steps, or a different order of the steps depicted in FIG. 2. The steps of FIG. 2 are described below with reference to components discussed above.

In block 202, the computing device 100 (e.g., the processing device 102) identifies a group of parameters 116 for configuring a machine-learning model. For example, the computing device 100 can receive a selection of the group of parameters 116 as user input.

In block 204, the computing device 100 determines descriptor values 112a-n for multiple versions of the machine-learning model 108a-n. The computing device 100 can implement this step by performing some or all of the steps shown in blocks 206-210.

For example, in block 206, the computing device 100 adjusts the value of a parameter (in the group of parameters 116) to generate a modified version of the machine-learning model 102a. The parameter can be a structural parameter or a non-structural parameter. In block 208, the computing device 100 trains the modified version of the machine-learning model 102a to determine a likelihood function 110a for the modified version of the machine learning model. In block 210, the computing device 100 determines a descriptor value 112a for the modified version of the machine-learning model using (i) a number of parameters in the group of parameters 116 and (ii) the likelihood function 110a for the modified version of the machine-learning model 102a. For example, if there are 10 parameters in the group of parameters 116, the computing device 100 can determine the descriptor value 112a based on there being 10 parameters in the group of parameters 116. The descriptor value 112a can be a number expressing a relationship between the number of parameters in the group of parameters 116 and the accuracy of the modified version of the machine-learning model 102a.

In some examples, the computing device 100 can iterate blocks 206-210 for multiple values (e.g., all values within a predefined range of values) of multiple parameters (e.g., all parameters) in the group of parameters 116. This can enable the computing device 100 to determine the descriptor values 112a-n for the multiple versions of the machine-learning model 108a-n.

In block 212, the computing device 100 determines that a particular version of the machine-learning model 114 has the lowest descriptor value among the descriptor values 112a-n by comparing the descriptor values 112a-n to one another.

In block 214, the computing device 100 executes the particular version of the machine-learning model 114 to perform a task in a computing environment. The computing device 100 can execute the particular version of the machine-learning model 114 based on it having the lowest descriptor value. For example, the computing device 100 can select the particular version of the machine-learning model 114 for performing the task in response to determining that the particular version of the machine-learning model 114 has the lowest descriptor value. The computing device 100 can then use the particular version of the machine-learning model 114 to perform the task.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. Some examples can be combined with other examples to yield further examples.

1. A method comprising:
identifying, by a processing device, a group of parameters for configuring a machine-learning model;
determining, by the processing device, descriptor values for multiple versions of the machine-learning model by performing a process that includes, for each parameter in the group of parameters:
adjusting a value of the parameter to generate a modified version of the machine-learning model;
training the modified version of the machine-learning model to determine a likelihood function for the modified version of the machine-learning model; and
determining a descriptor value for the modified version of the machine-learning model using (i) a number of parameters in the group of parameters and (ii) the likelihood function for the modified version of the machine-learning model, the descriptor value being a number expressing a relationship between the number of parameters in the group of parameters and the accuracy of the modified version of the machine-learning model;
determining, by the processing device, that a particular version of the machine-learning model has a lowest descriptor value among the descriptor values by comparing the descriptor values to one another; and
executing, by the processing device, the particular version of the machine-learning model to perform a task in a computing environment based on the particular version of the machine-learning model having the lowest descriptor value.

2. The method of claim 1, further comprising determining the descriptor value for the modified version of the machine-learning model by:
multiplying a first constant value by the number of parameters to determine a first value;
multiplying a second constant value by a logarithm of a maximum value of a likelihood function for the modified version of the machine-learning model to determine a second value; and
determining the descriptor value for the modified version of the machine-learning model by subtracting the second value from the first value.

3. The method of claim 2, wherein determining the descriptor values comprises performing the process for multiple parameter values for every parameter in the group of parameters.

4. The method of claim 3, wherein determining the descriptor values comprises performing the process for multiple parameter values for multiple combinations of parameters in the group of parameters.

5. The method of claim 1, wherein the group of parameters are hyperparameters, and at least one parameter in the group of parameters does not affect a topology of the machine-learning model.

6. The method of claim 1, wherein the machine-learning model is a first type of machine-learning model, and further comprising, prior to executing the particular version of the machine-learning model to perform the task:
determining another descriptor value for a second type of machine-learning model that is different from the first type of machine-learning model;
determining that the lowest descriptor value associated with the first type of machine-learning model is lower than the other descriptor value associated with the second type of machine-learning model; and
based on determining that the lowest descriptor value is lower than the other descriptor value, selecting the particular version of the machine-learning model for performing the task.

7. The method of claim 1, wherein determining the descriptor value for the modified version of the machine-learning model comprises:
generating a Pareto surface in a graph having (i) model accuracy along a first axis and (ii) the number of parameters used to configure the machine-learning model along a second axis;
determining a plot point on the Pareto surface in the graph; and
determine the descriptor value based on the plot point.

8. A non-transitory computer-readable medium comprising program code that is executable by a processing device for causing the processing device to:
identify a group of parameters for configuring a machine-learning model;
determine descriptor values for multiple versions of the machine-learning model by performing a process that includes, for each parameter in the group of parameters:
adjusting a value of the parameter to generate a modified version of the machine-learning model;
training the modified version of the machine-learning model to determine a likelihood function for the modified version of the machine-learning model; and
determining a descriptor value for the modified version of the machine-learning model using (i) a number of parameters in the group of parameters and (ii) the likelihood function for the modified version of the machine-learning model, the descriptor value being a number expressing a relationship between the number of parameters in the group of parameters and the accuracy of the modified version of the machine-learning model;
determine that a particular version of the machine-learning model has a lowest descriptor value among the descriptor values by comparing the descriptor values to one another; and
execute the particular version of the machine-learning model to perform a task in a computing environment based on the particular version of the machine-learning model having the lowest descriptor value.

9. The non-transitory computer-readable medium of claim 8, further comprising program code that is executable by the processing device for causing the processing device to determine the descriptor value for the modified version of the machine-learning model by:
multiplying a first constant value by the number of parameters to determine a first value;
multiplying a second constant value by a logarithm of a maximum value of a likelihood function for the modified version of the machine-learning model to determine a second value; and
determining the descriptor value for the modified version of the machine-learning model by subtracting the second value from the first value.

10. The non-transitory computer-readable medium of claim 8, wherein determining the descriptor values comprises performing the process for multiple parameter values for every parameter in the group of parameters.

11. The non-transitory computer-readable medium of claim 8, wherein determining the descriptor values comprises performing the process for multiple parameter values for multiple combinations of parameters in the group of parameters.

12. The non-transitory computer-readable medium of claim 8, wherein the group of parameters are hyperparameters, and at least one parameter in the group of parameters does not affect a topology of the machine-learning model.

13. The non-transitory computer-readable medium of claim 8, wherein the machine-learning model is a first type of machine-learning model, and further comprising program code that is executable by the processing device for causing the processing device to, prior to executing the particular version of the machine-learning model to perform the task:
determine another descriptor value for a second type of machine-learning model that is different from the first type of machine-learning model;
determine that the lowest descriptor value associated with the first type of machine-learning model is lower than the other descriptor value associated with the second type of machine-learning model; and
based on determining that the lowest descriptor value is lower than the other descriptor value, select the particular version of the machine-learning model for performing the task.

14. The non-transitory computer-readable medium of claim 8, further comprising program code that is executable by the processing device for causing the processing device to determine the descriptor value for the modified version of the machine-learning model by:
generating a Pareto surface in a graph having (i) model accuracy along a first axis and (ii) the number of parameters used to configure the machine-learning model along a second axis;
determining a plot point on the Pareto surface in the graph; and
determine the descriptor value based on the plot point.

15. A system comprising:
a processing device; and
a memory device on which instructions that are executable by the processing device are stored for causing the processing device to:
identify a group of parameters for configuring a machine-learning model;
determine descriptor values for multiple versions of the machine-learning model by performing a process that includes, for each parameter in the group of parameters:
adjusting a value of the parameter to generate a modified version of the machine-learning model;
training the modified version of the machine-learning model to determine a likelihood function for the modified version of the machine-learning model; and
determining a descriptor value for the modified version of the machine-learning model using (i) a number of parameters in the group of parameters and (ii) the likelihood function for the modified version of the machine-learning model, the descriptor value being a number expressing a relationship between the number of parameters in the group of parameters and the accuracy of the modified version of the machine-learning model;
determine that a particular version of the machine-learning model has a lowest descriptor value among the descriptor values by comparing the descriptor values to one another; and
execute the particular version of the machine-learning model to perform a task in a computing environment based on the particular version of the machine-learning model having the lowest descriptor value.

16. The system of claim 15, wherein the memory device further comprises instructions that are executable by the processing device for causing the processing device to determine the descriptor value for the modified version of the machine-learning model by:
multiplying a first constant value by the number of parameters to determine a first value;
multiplying a second constant value by a logarithm of a maximum value of a likelihood function for the modified version of the machine-learning model to determine a second value; and
determining the descriptor value for the modified version of the machine-learning model by subtracting the second value from the first value.

17. The system of claim 15, wherein determining the descriptor values comprises performing the process for multiple parameter values for every parameter in the group of parameters.

18. The system of claim 15, wherein the group of parameters are hyperparameters, and at least one parameter in the group of parameters does not affect a topology of the machine-learning model.

19. The system of claim 15, wherein the machine-learning model is a first type of machine-learning model, and wherein the memory device further comprises instructions that are executable by the processing device for causing the processing device to, prior to executing the particular version of the machine-learning model to perform the task:
determine another descriptor value for a second type of machine-learning model that is different from the first type of machine-learning model;
determine that the lowest descriptor value associated with the first type of machine-learning model is lower than the other descriptor value associated with the second type of machine-learning model; and
based on determining that the lowest descriptor value is lower than the other descriptor value, select the particular version of the machine-learning model for performing the task.

20. The system of claim 15, wherein the memory device further comprises instructions that are executable by the processing device for causing the processing device to determine the descriptor value for the modified version of the machine-learning model by:
generating a Pareto surface in a graph having (i) model accuracy along a first axis and (ii) the number of parameters used to configure the machine-learning model along a second axis;
determining a plot point on the Pareto surface in the graph; and
determine the descriptor value based on the plot point.
